(19) United States
(12) Patent Application Publication
(10) Pub. No.: US 2024/0255023 A1
(43) Pub. Date: Aug. 1, 2024

(54) RETENTION SYSTEMS FOR SLIDING MEMBERS FOR USE IN LINEAR MOTION ASSEMBLIES

(71) Applicant: SAINT-GOBAIN PERFORMANCE PLASTICS CORPORATION, SOLON, OH (US)

(72) Inventors: Kaibo SU, Shanghai (CN); Gege LI, Shanghai (CN); Feng SHI, Shanghai (CN); Andrew Zang, Shanghai (CN)

(21) Appl. No.: 18/426,774

(22) Filed: Jan. 30, 2024

(30) Foreign Application Priority Data
Jan. 31, 2023 (CN) 202310047225.1

(51) Int. Cl. F16C 29/02; F16C 33/02

(52) U.S. Cl. CPC F16C 29/02; F16C 33/02

(57) ABSTRACT

A linear motion assembly including: a first component; a second component; and a sliding member disposed between the first and second components; and a retention system adapted to retain the sliding member between the first component and the second component, where the retention system includes a retention frame and at least one spring element, where the sliding member is disposed between the retention frame and the spring element, where the spring element provides a biasing force on the sliding member.

### CROSS-REFERENCE TO RELATED APPLICATIONS

This application claims priority to and the benefit of Chinese Patent Application No. 202310047225.1, filed on Jan. 31, 2023, by Kaibo S U et al., entitled “RETENTION SYSTEMS FOR SLIDING MEMBERS FOR USE IN LINEAR MOTION ASSEMBLIES,” the disclosure of which is assigned to the current assignee hereof and incorporated herein by reference in its entirety for all purposes.

### FIELD OF THE DISCLOSURE

The present disclosure relates to linear motion assemblies, and more particularly to sliding members for use in linear motion assemblies.

### RELATED ART

Linear motion assemblies generally include multiple components translating longitudinally with respect to one another. One or more sliding members can facilitate translation. The sliding members typically include bearings (e.g. sliding bearings, ball bearings, and caged ball bearings) formed of hardened-steel. Paints, coatings, finishes, and lubricants, such as grease, may be coated on the bearings to reduce frictional coefficients and facilitate sliding. These materials can leak or peel during installation and use, contaminating the assembly, grinding against the components during translation, and introducing a carrier for particulate, such as dust and debris. Further, these sliding members may be misaligned over time, causing inadequate force control and inferior tolerance compensation, resulting in inefficient sliding performance within the linear motion assembly.

Therefore, a need exists for a linear motion assembly, such as an adjustable seat track assembly, capable of avoiding the known problems of misalignment associated with the use of bearings while maintaining sufficient structural strength and tolerance compensation properties as now demanded by the industry.

### SUMMARY

Embodiments herein may include a linear motion assembly including: a first component; a second component; and a sliding member disposed between the first and second components; and a retention system adapted to retain the sliding member between the first component and the second component, where the retention system includes a retention frame and at least one spring element, where the sliding member is disposed between the retention frame and the spring element, where the spring element provides a biasing force on the sliding member.

Embodiments herein may include a linear motion assembly including: a first component; a second component; and a plurality of sliding members disposed between the first and second components; and a retention system including a plurality of spring elements, where a first spring element of the plurality of spring elements provides a first biasing force on a first sliding member of the plurality of sliding members, and a second spring element of the plurality of spring elements provides a second biasing force on a second sliding member of the plurality of sliding members, where the first biasing force is independent from the second biasing force.

### BRIEF DESCRIPTION OF THE DRAWINGS

Embodiments are illustrated by way of example and are not intended to be limited in the accompanying figures.

FIG. 1 illustrates a cross-sectional elevation view of an exemplary linear motion assembly according to a number of embodiments.

FIG. 2A illustrates a cross-sectional top view of an exemplary linear motion assembly according to a number of embodiments.

FIG. 2B illustrates a top perspective view of the exemplary linear motion assembly of FIG. 2A according to a number of embodiments.

FIG. 2C illustrates an exploded top perspective view of the exemplary linear motion assembly of FIGS. 2A-2B according to a number of embodiments.

FIG. 2D illustrates a top cut-away cross-sectional view of the exemplary linear motion assembly of FIGS. 2A-2C according to a number of embodiments.

FIG. 3A illustrates an exploded top perspective view of the exemplary linear motion assembly according to a number of embodiments.

FIG. 3B illustrates a top cut-away cross-sectional view of the exemplary linear motion assembly of FIG. 3A according to a number of embodiments.

FIG. 4 illustrates a top perspective view of a sliding member for the exemplary linear motion assembly according to a number of embodiments.

FIG. 5 illustrates a front view of a slide pin sliding member for the exemplary linear motion assembly according to a number of embodiments.

FIG. 6A illustrates a front view of a slide pin sliding member for the exemplary linear motion assembly according to a number of embodiments.

FIG. 6B illustrates a front view of a slide pin sliding member for the exemplary linear motion assembly according to a number of embodiments.

FIG. 7 illustrates a front view of a slide pin sliding member for the exemplary linear motion assembly according to a number of embodiments.

FIG. 8 illustrates an exploded partial perspective view of an exemplary linear motion assembly according to a number of embodiments.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the linear motion arts.

Skilled artisans will recognize that the disclosure of a linear motion assembly 100 according to embodiments herein may include any system with two neighboring members in linear motion relative to one another. As described herein, the linear motion assembly may include, but is not intended to be limited to, seat track assemblies, seat cushion depth adjustment assemblies, seat length adjustment assemblies, seat back adjustment assemblies, adjustable sliding console, sun and moon roof sliding mechanisms, window height adjustment systems, sliding doors, telescoping assemblies such as steering systems, slidable racks and brackets such as found in dishwashers and oven racks, sliding drawers and cabinets, sliding surfaces, linear actuators, motors, gears, office components such as printers, fax machines, scanners, copiers, and components performing a plurality of such operations, assembly processes, automated machines and assemblies, or any other similar component or assembly which incorporates linear motion exhibited between two or more components. Skilled artisans will further recognize that while the disclosure is directed to linear motion assemblies, certain applications require rotational flexibility, where the sliding member provides a low friction surface for both linear and rotational translations.

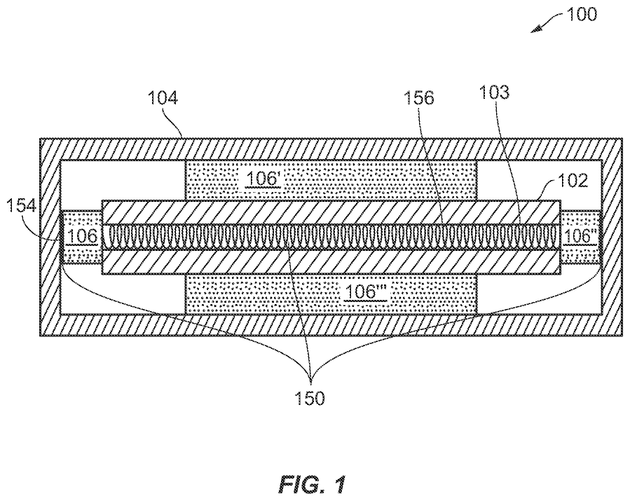

FIG. 1 illustrates a cross-sectional elevation view of an exemplary linear motion assembly according to a number of embodiments. As shown in FIG. 1, the linear motion assembly 100 may include a first component 102, a second component 104, and a plurality of sliding members 106, 106′, 106″, 106″′ disposed between the first and second components 102 and 104. Linear motion between the first and second components 102 and 104 may occur in a direction generally into and out of the page. In certain applications, rotational motion can additionally occur in a clockwise or counterclockwise manner. In a number of embodiments, the linear motion assembly 100 may further include a retention system 150. The retention system 150 may be adapted to retain at least one sliding member 106, 106′, 106″, 106″′ between the first component 102 and the second component 104. In a number of embodiments, the retention system 150 may include a retention body 152 and at least one spring element 156. In a number of embodiments, at least one sliding member 106, 106′, 106″, 106″′ may be disposed between the retention body 154 and the spring element 156. In a number of embodiments, retention body 154 may contact the at least one sliding member 106, 106′, 106″, 106″′ and at least one of the first component 102 or second component 104. In a number of embodiments, the retention body 154 may be fixed to at least one of the first component 102 or second component 104. In a number of embodiments, the spring element 156 may contact the at least one sliding member 106, 106′, 106″, 106″′ and at least one of the first component 102 or second component 104. In a number of embodiments, the spring element 156 may be fixed to at least one of the first component 102 or second component 104. The at least one of the retention body 154 or spring element 156 can be adhered or otherwise secured to at least one of the first component 102 or second component 104 by an interference fit, an adhesive, or a mechanical fixture, such as a pin or collar. In a number of embodiments, the spring element 156 fits within a bore of at least one of the first component 102 or second component 104. As shown in FIG. 1, the spring element 156 runs through a bore 103 of the first component 102. In a number of embodiments, the at least one spring element 156 may provide a biasing force on at least one sliding member 106, 106′, 106″, 106″′.

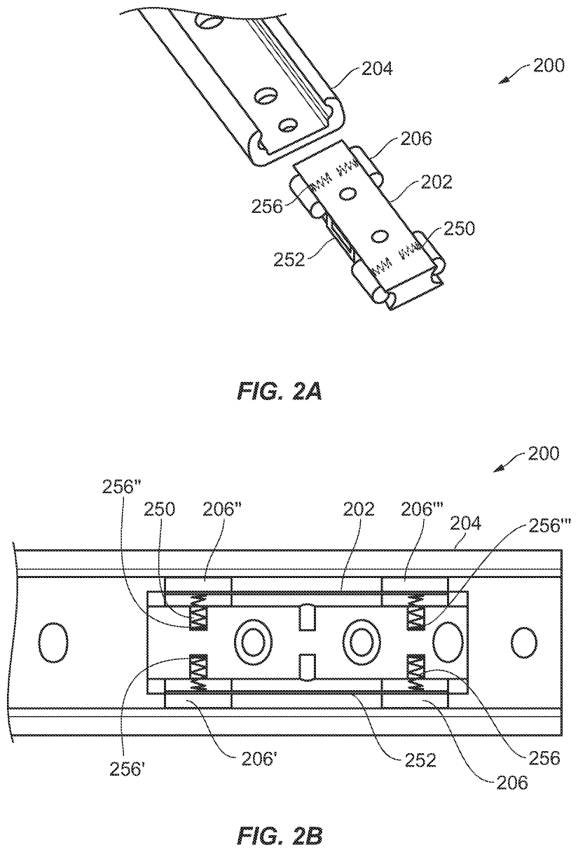

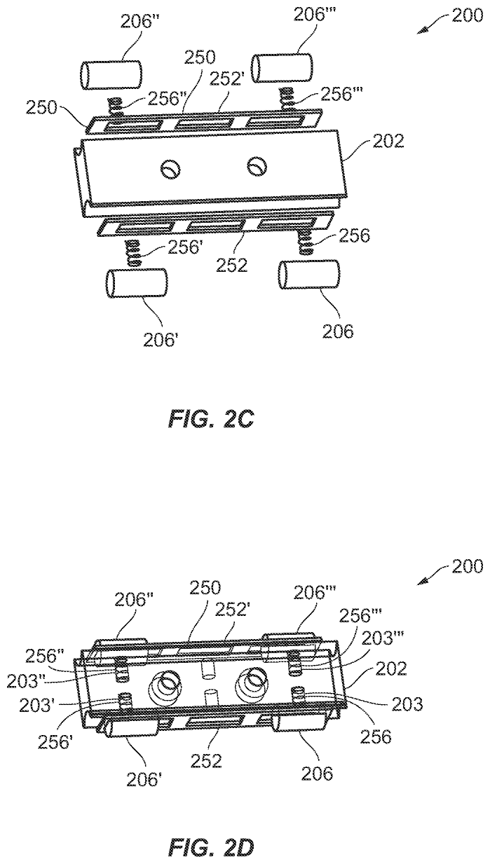

FIG. 2A illustrates a cross-sectional top view of an exemplary linear motion assembly according to a number of embodiments. FIG. 2B illustrates a top perspective view of the exemplary linear motion assembly of FIG. 2A according to a number of embodiments. FIG. 2C illustrates an exploded top perspective view of the exemplary linear motion assembly of FIGS. 2A-2B according to a number of embodiments. FIG. 2D illustrates a top cut-away cross-sectional view of the exemplary linear motion assembly of FIGS. 2A-2C according to a number of embodiments. In a number of embodiments, the linear motion assembly 200 may include a first component 202, a second component 204, and a plurality of sliding members 206, 206′, 206″, 206″′ disposed between the first and second components 202 and 204. In a number of embodiments, as shown best in FIGS. 2C and 2D, the at least one of the first component 202 or the second component 204 has a concave exterior surface adapted to house the at least one sliding member 206, 206′, 206″, 206″′. In a number of embodiments, at least one sliding member of the plurality of sliding members 206, 206′, 206″, 206″′ may be adapted to longitudinally translate with respect to at least one of the first component 202 or the second component 204. In a number of embodiments, the first component 202 may be adapted to longitudinally translate with respect to the second component 204. In a number of embodiments, the second component 204 may be adapted to longitudinally translate with respect to the first component 202.

In a number of embodiments, the linear motion assembly 200 may further include a retention system 250. The retention system 250 may be adapted to retain at least one sliding member 206, 206′, 206″, 206″′ between the first component 202 and the second component 204. In a number of embodiments, the retention system 250 may include at least one retention frame 252, 252′ and at least one spring element 256. In a number of embodiments, at least one sliding member 206, 206′, 206″, 206″′ may be disposed between the at least one retention frame 252, 252′ and at least one of the plurality of spring elements 256, 256′, 256″, 256″′. In a number of embodiments, at least one of the plurality of spring elements 256, 256′, 256″, 256″′ may contact the at least one sliding member 206, 206′, 206″, 206″′ and at least one of the first component 202 or second component 204. In a number of embodiments, at least one of the plurality of spring elements 256, 256′, 256″, 256″′ may be fixed to at least one of the first component 202 or second component 204. In a number of embodiments, at least one of the plurality of spring elements 256, 256′, 256″, 256″′ may fit within a bore 203, 203′, 203″, 203″′ of at least one of the first component 202 or second component 204.

In a number of embodiments, at least one of the plurality of spring elements 256, 256′, 256″, 256″′ may provide a biasing force on at least one sliding member 206, 206′, 206″, 206″′. In a number of embodiments, at least one of the plurality of spring elements 256, 256′, 256″, 256″′ may provide a biasing force on at least one sliding member 206, 206′, 206″, 206″′ of at least 0.01N and not greater than 500N. In a number of embodiments, as shown in FIGS. 2A-2D, the retention system 250 may include a plurality of spring elements 256, 256′, 256″, 256″′. The plurality of spring elements may include a first spring element 256 providing a first biasing force on a first sliding member 206, a second spring element 256′ providing a second biasing force on a second sliding member 206′, a third spring element 256″ providing a third biasing force on a third sliding member 206″, a fourth spring element 256″′ providing a fourth biasing force on a fourth sliding member 206″′. In a number of embodiments, the first biasing force, the second biasing force, the third biasing force, and the fourth biasing force may each be independent from one another. As defined herein “independent” may be defined where a biasing force from a first spring element on a sliding member may not be effected by a biasing force from another spring element on a sliding member. In a number of embodiments, the first biasing force may be greater than at least one of the second biasing force, third biasing force, or fourth biasing force. In a number of embodiments, the first biasing force may be less than at least one of the second biasing force, third biasing force, or fourth biasing force. In a number of embodiments, the first biasing force may be the same as at least one of the second biasing force, third biasing force, or fourth biasing force. In a number of embodiments, the second biasing force may be greater than at least one of the first biasing force, third biasing force, or fourth biasing force. In a number of embodiments, the second biasing force may be less than at least one of the first biasing force, third biasing force, or fourth biasing force. In a number of embodiments, the second biasing force may be the same as at least one of the first biasing force, third biasing force, or fourth biasing force. In a number of embodiments, the third biasing force may be greater than at least one of the first biasing force, second biasing force, or fourth biasing force. In a number of embodiments, the third biasing force may be less than at least one of the first biasing force, second biasing force, or fourth biasing force. In a number of embodiments, the third biasing force may be the same as at least one of the first biasing force, second biasing force, or fourth biasing force. In a number of embodiments, the fourth biasing force may be greater than at least one of the first biasing force, second biasing force, or third biasing force. In a number of embodiments, the fourth biasing force may be less than at least one of the first biasing force, second biasing force, or third biasing force. In a number of embodiments, the fourth biasing force may be the same as at least one of the first biasing force, second biasing force, or third biasing force.

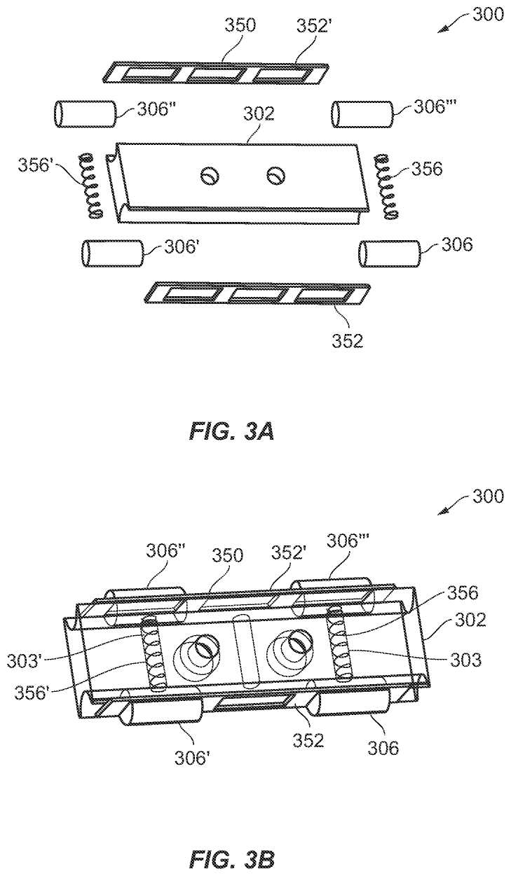

FIG. 3A illustrates an exploded top perspective view of the exemplary linear motion assembly according to a number of embodiments. FIG. 3B illustrates a top cut-away cross-sectional view of the exemplary linear motion assembly of FIG. 3A according to a number of embodiments. In a number of embodiments, the linear motion assembly 300 may include a first component 302, a second component (not shown), and a plurality of sliding members 306, 306′, 306″, 306″′ disposed between the first component 302 and second component (not shown). In a number of embodiments, as shown best in FIGS. 3A and 3B, the at least one of the first component 302 or the second component (not shown) has a concave exterior surface adapted to house the at least one sliding member 306, 306′, 306″, 306″′. In a number of embodiments, at least one sliding member of the plurality of sliding members 306, 306′, 306″, 306″′ may be adapted to longitudinally translate with respect to at least one of the first component 302 or the second component (not shown). In a number of embodiments, the first component 302 may be adapted to longitudinally translate with respect to the second component (not shown). In a number of embodiments, the second component (not shown) may be adapted to longitudinally translate with respect to the first component 302.

In a number of embodiments, the linear motion assembly 300 may further include a retention system 350. The retention system 350 may be adapted to retain at least one sliding member 306, 306′, 306″, 306″′ between the first component 302 and the second component (not shown). In a number of embodiments, the retention system 350 may include at least one retention frame 352, 352′ and at least one spring element 356, 356′. In a number of embodiments, at least one sliding member 306, 306′, 306″, 306″′ may be disposed between the at least one retention frame 352, 352′ and at least one of the plurality of spring elements 356, 356′. In a number of embodiments, at least one of the plurality of spring elements 356, 356′ may contact the at least one sliding member 306, 306′, 306″, 306″′ and at least one of the first component 302 or second component (not shown). In a number of embodiments, at least one of the plurality of spring elements 356, 356′ may be fixed to at least one of the first component 302 or second component (not shown). In a number of embodiments, at least one of the plurality of spring elements 356, 356′ may fit within a bore of at least one of the first component 302 or second component (not shown). As shown best in FIG. 3B, at least one of the plurality of spring elements 356, 356′ may run completely through a bore 303, 303′, of the first component 302. In a number of embodiments, at least one of the plurality of spring elements 356, 356′ may provide a biasing force on at least one sliding member 306, 306′, 306″, 306″′. In a number of embodiments, as shown in FIGS. 3A-3B, the retention system 350 may include a plurality of spring elements 356, 356′. The plurality of spring elements 356, 356′ may include a first spring element 356 providing a first biasing force on a first sliding member 306 and a fourth sliding member 306″′, a second spring element 356′ providing a second biasing force on a second sliding member 306′ and a third sliding member 306″. In a number of embodiments, the first biasing force and the second biasing force may each be independent from one another. As defined herein “independent” may be defined where a biasing force from a first spring element on a sliding member may not be effected by a biasing force from another spring element on a sliding member. In a number of embodiments, the first biasing force may be greater than the second biasing force. In a number of embodiments, the first biasing force may be less than the second biasing force. In a number of embodiments, the first biasing force may be the same as the second biasing force.

In an embodiment, the at least one retention frame can include a rigid material, such as, for example, a metal, an alloy, a ceramic, or a polymer. In a particular embodiment, the at least one retention frame can include a metal, such as steel.

In an embodiment, the at least one spring element can include a rigid material, such as, for example, a metal, an alloy, an elastomer, or a polymer. In a particular embodiment, the at least one spring element can include a metal, such as spring steel. In an embodiment, the at least one spring element as described herein may be a U-shaped, C-shaped, or V-shaped cross-sectional spring. As contemplated in at least one embodiment described herein, the at least one spring element can be a coil spring that includes a length of material formed into a helical spring having a plurality of coils. In an embodiment, the energizer 108 can include at least 2 coils, such as at least 3 coils, at least 4 coils, at least 5 coils, at least 10 coils, at least 100 coils, at least 200 coils, at least 300 coils, at least 400 coils, at least 500 coils, or even at least 1000 coils. The length of material forming the at least one spring element can have a polygonal or ellipsoidal cross section. For example, in an embodiment, the at least one spring element can be formed from circular wire. In another embodiment, the at least one spring element can be formed from a ribbon of material wound into a plurality of coils. The coils of the at least one spring element can be adjacent or even partially overlap one another. In a particular instance the coils can be parallel to one another. In another instance, the coils can cant relative to each other. That is, the coils can be angularly offset and angled with respect to one another.

In the relaxed state, the at least one spring element may have a generally round cross section. That is, the at least one spring element may be a helical spring, as described above. In other embodiments, the at least one spring element may define a generally polygonal cross-sectional profile. In a more particular embodiment, the at least one spring element may have a generally T-shaped cross-sectional profile. In another embodiment, the at least one spring element may have an ellipsoidal cross section. For example, in a non-illustrated embodiment, the at least one spring element may have an ovular or circular cross-sectional profile. In yet a further embodiment, the cross section of the at least one spring element may be partially ellipsoidal and partially polygonal. That is, the cross section of the at least one spring element may have linear portions and arcuate portions. The wire forming the coil of the at least one spring element may be rectangular, square, circular, elliptical, or keystone in cross section. The wire forming the coil of the at least one spring element may be turned at a pitch of between 0.025 mm and 25.4 mm, such as between 0.1 mm and 3 mm. The wire forming the coil of the at least one spring element may have a wire diameter of between 0.025 mm and 25.4 mm, such as between 0.05 mm and 0.6 mm. The wire forming the coil of the at least one spring element may have an energizer diameter of between 0.05 mm and 40,000 mm, such as between 0.5 mm and 20 mm. Alternatively, the at least one spring element can be a blade spring, a leaf spring, or a feather spring (not shown).

In accordance with one or more embodiments, the at least one spring element may provide a spring rate in a radially outward direction so as to outwardly bias the sliding member. In certain embodiments, the at least one spring element may exhibit progressive, linear, or degressive spring rate characteristic. In an embodiment, the spring rate of the at least one spring element may be at least 10N/mm, such as at least 50 N/mm, at least 100 N/mm, at least 150 N/mm, at least 200 N/mm, at least 250 N/mm, at least 300 N/mm, at least 350 N/mm, or even at least 400 N/mm. In an embodiment, the spring rate of at least one spring element may be no greater than 800 N/mm, such as no greater than 700 N/mm, no greater than 600 N/mm, no greater than 550 N/mm, no greater than 500 N/mm, or even no greater than 450 N/mm Structures with high spring rates may provide greater structural support with reduced tolerance absorption, while structures with low spring rates may better absorb tolerance and misalignment within the linear motion assembly.

In an embodiment, at least one of the first component or second component described herein can include a rigid material, such as, for example, a metal, an alloy, a ceramic, or a polymer. In this regard, at least one of the first component or second component can resist significant deformation upon application of a loading force condition, e.g., a transverse force applied to at least one of the first component or second component from a neighboring component. In a particular embodiment, at least one of the first component or second component can include steel.

In an embodiment, at least one of the retention frame, the spring element, first component or second component or portions thereof may optionally be coated with a layer to protect against corrosion or other potential damage. In particular embodiments, at least one of the first component or second component may be coated with one or more temporary corrosion protection layers to prevent corrosion thereof prior to processing. Each of the layers can have a thickness in a range of 1 micron and 50 microns, such as in a range of 7 microns and 15 microns. The layers can include a phosphate of zinc, iron, manganese, or any combination thereof. Additionally, the layers can be a nano-ceramic layer. Further, layers can include functional silanes, nano-scaled silane based primers, hydrolyzed silanes, organosilane adhesion promoters, solvent/water based silane primers, chlorinated polyolefins, passivated surfaces, commercially available zinc (mechanical/galvanic) or zinc-nickel coatings, or any combination thereof. Temporary corrosion protection layers can be removed or retained during processing.

In particular embodiments, at least one of the retention frame, the spring element, first component or second component or portions thereof may further include a permanent corrosion resistant coating. The corrosion resistant coating can have a thickness of in a range of 1 micron and 50 microns, such as in a range of 5 microns and 20 microns, or even in a range of 7 microns and 15 microns. The corrosion resistant coating can include an adhesion promoter layer and an epoxy layer. The adhesion promoter layer can include a phosphate of zinc, iron, manganese, tin, or any combination thereof. Additionally, the adhesion promoter layer can be nano-ceramic layer. The adhesion promoter layer can include functional silanes, nano-scaled silane based layers, hydrolyzed silanes, organosilane adhesion promoters, solvent/water based silane primers, chlorinated polyolefins, passivated surfaces, commercially available zinc (mechanical/galvanic) or Zinc-Nickel coatings, or any combination thereof.

The epoxy layer can be a thermal cured epoxy, a UV cured epoxy, an IR cured epoxy, an electron beam cured epoxy, a radiation cured epoxy, or an air cured epoxy. Further, the epoxy resin can include polyglycidylether, diglycidylether, bisphenol A, bisphenol F, oxirane, oxacyclopropane, ethylenoxide, 1,2-epoxypropane, 2-methyloxirane, 9,10-epoxy-9,10-dihydroanthracene, or any combination thereof. The epoxy resin can include synthetic resin modified epoxies based on phenolic resins, urea resins, melamine resins, benzoguanamine with formaldehyde, or any combination thereof. By way of example, epoxies can include mono epoxoide, bis epoxide, linear tris epoxide, ramified tris epoxide, or any combination thereof, wherein C_{X}H_{Y}X_{Z}A_{U} is a linear or ramified saturated or unsaturated carbon chain with optionally halogen atoms X_{Z} substituting hydrogen atoms, and optionally where atoms like nitrogen, phosphorous, boron, etc., are present and B is one of carbon, nitrogen, oxygen, phosphorous, boron, sulfur, etc.

The epoxy resin can further include a hardening agent. The hardening agent can include amines, acid anhydrides, phenol novolac hardeners such as phenol novolac poly[N-(4-hydroxyphenyl)maleimide] (PHPMI), resole phenol formaldehydes, fatty amine compounds, polycarbonic anhydrides, polyacrylate, isocyanates, encapsulated polyisocyanates, boron trifluoride amine complexes, chromic-based hardeners, polyamides, or any combination thereof. Generally, acid anhydrides can conform to the formula R—C═O—O—C═O—R′ where R can be C_{X}H_{Y}X_{Z}A_{U} as described above. Amines can include aliphatic amines such as monoethylamine, diethylenetriamine, triethylenetetraamine, and the like, alicyclic amines, aromatic amines such as cyclic aliphatic amines, cyclo aliphatic amines, amidoamines, polyamides, dicyandiamides, imidazole derivatives, and the like, or any combination thereof. Generally, amines can be primary amines, secondary amines, or tertiary amines conforming to the formula R₁R₂R₃N where R can be C_{X}H_{Y}X_{Z}A_{U} as described above.

In an embodiment, the epoxy layer can include fillers to improve conductivity, such as carbon fillers, carbon fibers, carbon particles, graphite, metallic fillers such as bronze, aluminum, and other metals and their alloys, metal oxide fillers, metal coated carbon fillers, metal coated polymer fillers, or any combination thereof. The conductive fillers can allow current to pass through the epoxy coating and can increase the conductivity of the coated bushing as compared to a coated bushing without conductive fillers.

In an embodiment, the epoxy layer can increase the corrosion resistance. For example, the epoxy layer can substantially prevent corrosive elements, such as water, salts, and the like, from contacting at least one of the first component or second component, thereby inhibiting chemical corrosion thereof. Additionally, the epoxy layer can inhibit galvanic corrosion by preventing contact between dissimilar metals.

Application of the corrosion resistant layer can include applying an epoxy coating. The epoxy can be a two-component epoxy or a single component epoxy. Advantageously, a single component epoxy can have a longer working life. The working life can be the amount of time from preparing the epoxy until the epoxy can no longer be applied as a coating. For example, a single component epoxy can have a working life of months compared to a working life of a two-component epoxy of a few hours.

In an embodiment, the epoxy layer can be applied by spray coating, e-coating, dip spin coating, electrostatic coating, flow coating, roll coating, knife coating, coil coating, or the like. Additionally, the epoxy layer can be cured, such as by thermal curing, UV curing, IR curing, electron beam curing, irradiation curing, or any combination thereof. Preferably, the curing can be accomplished without increasing the temperature of the component above the breakdown temperature of any of the sliding layer, the adhesive layer, the woven mesh, or the adhesion promoter layer. Accordingly, the epoxy may be cured below about 250° C., even below about 200° C.

In an embodiment, the corrosion resistant coating, and particularly the epoxy layer, can be applied to cover the exposed edges of at least one of the first component or second component. E-coating and electrostatic coating can be particularly useful in applying the corrosion resistant coating layers to all exposed metallic surfaces without coating the non-conducting sliding layer. Further, it is preferable for the corrosion resistant coating to continuously cover the exposed surfaces without cracks or voids. The continuous, conformal covering can substantially prevent corrosive elements such as salts and water from contacting at least one of the retention frame, the spring element, first component or second component or portions thereof. In certain embodiments, at least one of the retention frame, the spring element, first component or second component or portions thereof can be identical, or nearly identical with respect to one another.

In accordance with one or more of the embodiments described herein, at least one of the sliding members can at least partially include a substrate. The substrate may include a rigid material, such as, for example, a metal, an alloy, a ceramic, or a polymer. In this regard, at least one of the sliding members can resist significant deformation upon application of a loading force condition, e.g., a transverse force applied to at least one of the sliding members from a neighboring component. In a particular embodiment, at least one of the sliding members can include steel such as spring steel.

In accordance with one or more of the embodiments described herein, at least one of the sliding members can at least partially include a low friction material. For example, a fluoropolymer, such as polytetrafluoroethylene (PTFE). Other exemplary fluoropolymers can include a fluorinated ethylene propylene (FEP), a polyvinylidene fluoride (PVDF), a perfluoroalkoxy (PFA), a terpolymer of tetrafluoroethylene, a hexafluoropropylene and vinylidene fluoride (THV), a polychlorotrifluoroethylene (PCTFE), an ethylene tetrafluoroethylene copolymer (ETFE), an ethylene chlorotrifluoroethylene copolymer (ECTFE), or any combination thereof. Additionally, it is possible to use other sliding materials, such as for example, those marketed by the applicant under the trademark Norglide®. In another embodiment, at least one of the sliding members can include a polyimide, such as for example, those marketed by the applicant under the trademark Meldin® 2000, 7000, 8100, or 9000, or a thermoplastic, such as for example, those marketed by the Applicant under the trademark Meldin® 1000, 3100, or 5000. In a number of embodiments, the substrate may be at least partially coated with the low friction material on at least one of the sliding members, or vice versa. In an embodiment, at least one of the sliding members described above may be free of an externally applied lubricant. In an embodiment, at least one of the sliding members may be self-lubricating.

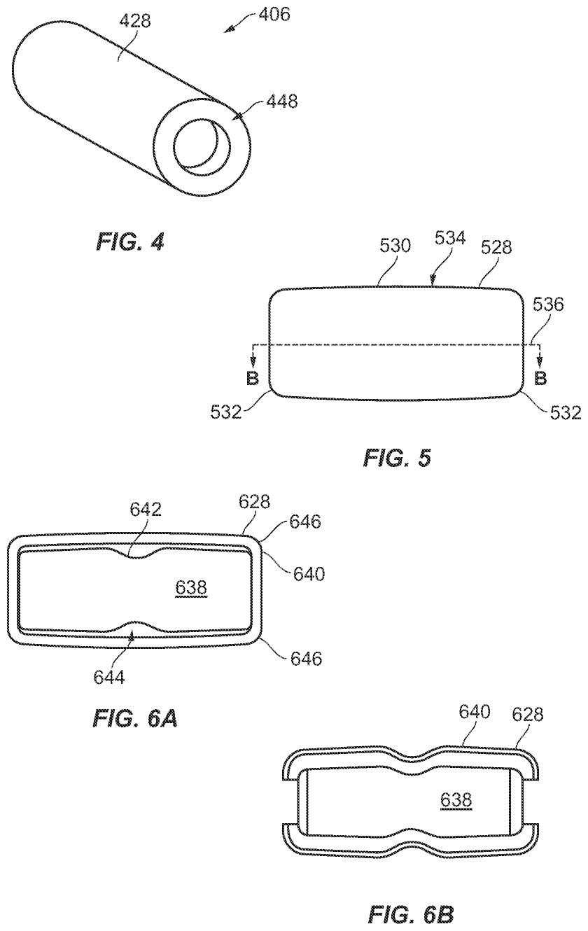

FIG. 4 illustrates a top perspective view of a sliding member for the exemplary linear motion assembly according to a number of embodiments. In an embodiment, as shown in FIG. 54 at least one of the sliding members 406 described above may include a slide pin 428. The slide pin can include an elongated cylinder having a length, L_{SP}, and a diameter, D_{SP}. The slide pin 428 can define an aspect ratio, as measured by a ratio of the length to width. Unlike with ball bearings, it is not required that the aspect ratio be 1:1. For example, the slide pin 428 can have an aspect ratio of at least 1.1:1, such as at least 1.5:1, at least 2:1, at least 3:1, at least 4:1, at least 5:1, or even at least 10:1. The aspect ratio may be as great as 1,000:1. In another embodiment, the slide pin 428 can have an aspect ratio of no greater than 0.9:1, such as no greater than 0.5:1, or even no greater than 0.25:1. The aspect ratio may be as small as 0.001:1.

Prior to installation between the first and second components, the slide pin 428 can have a generally cylindrical sidewall extending between opposing terminal ends. The generally cylindrical sidewall can define an average preassembled diameter, as measured prior to installation between the first and second components, and an average assembled diameter, as measured after installation between the first and second components, different than the average preassembled diameter. More particularly, the average assembled diameter can be less than the average preassembled diameter. In this regard, the slide pin 428 may be oversized prior to installation, adapted to absorb tolerances within the space between the first and second components. Additionally, the slide pins 428 may maintain a zero clearance between the first and second components.

Alternatively, in an embodiment, at least one of the slide pins 428 may have an outer surface defining an ellipsoidal cross section. The sidewall of the slide pins 428 may have an arcuate cross-sectional profile defining a closed curve. In a more particular embodiment, the radius of curvature of the sidewall may be constant along a perimeter thereof. In another more particular embodiment, the radius of curvature of the sidewall may be different at different locations therealong. For example, the sidewall may define an ovular cross-sectional profile. Exemplary ovular profiles include a Cassini oval, a superellipse, a Cartesian oval, an elliptical oval, or a vesica piscis.

In another embodiment, at least one of the slide pins 428 may have a polygonal cross section. For example, the slide pins 428 may have a cross section selected from the following shapes: a triangle, a quadrilateral, a pentagon, a hexagon, a heptagon, an octagon, a nonagon, a decagon, a hendecagon, a dodecagon, or another suitable polygonal shape. In an embodiment, the cross-sectional profile of at least one of the slide pins 428 may be a regular polygon such that it is both equilateral and equiangular. In another embodiment, the cross-sectional profile of at least one of the slide pins 428 may be an irregular polygon such that it is not equilateral, equiangular, or both.

In yet another embodiment, at least one of the slide pins 428 may have a cross section with a polygonal portion and an ellipsoidal portion. For example, a first portion of the cross section may include a generally arcuate surface while a second portion may include one or more straight segments interconnected by a relative angle therebetween. In an embodiment, an outer profile having both polygonal portions and ellipsoidal portions may more accurately fit within the space between the first and second components, forming a more uniform contact interface and creating a more uniform pressure profile therebetween.

FIG. 5 illustrates a front view of a slide pin sliding member for the exemplary linear motion assembly according to a number of embodiments. Referring to FIG. 5, in a more particular embodiment, prior to installation between the first and second components, the slide pin 528 can have a barrel shape, such that the diameter of the slide pin 528 is greater at a middle portion 530 as compared to an end portion 532 thereof. For example, the diameter of the middle portion can be 101% the diameter of the end portion, such as at least 102% the diameter of the end portion, at least 103% the diameter of the end portion, at least 104% the diameter of the end portion, at least 105% the diameter of the end portion, at least 110% the diameter of the end portion, at least 115% the diameter of the end portion, at least 120% the diameter of the end portion, at least 125% the diameter of the end portion, at least 130% the diameter of the end portion, at least 135% the diameter of the end portion, at least 140% the diameter of the end portion, at least 145% the diameter of the end portion, or even at least 150% the diameter of the end portion. The diameter of the middle portion can be no greater than 250% the diameter of the end portion, such as no greater than 200% the diameter of the end portion, or even no greater than 175% the diameter of the end portion.

In an embodiment, an outer surface 534 of the slide pin 528 may extend at a constant angle relative to a central axis 536 of the slide pin 528, as measured from one of the end portions 532 to the middle portion 530. In another embodiment, an angle of the outer surface 534 can vary between the end portion 532 and the middle portion 530.

In a particular embodiment, upon installation between the first and second components, the outer surface 534 of at least one of the slide pins 528 may deform from a barrel shape to a cylindrical, or generally cylindrical, shape where the diameter of the middle portion 530, as measured in the assembled state, may be less than the diameter of the middle portion 530, as measured prior to assembly. In such a manner, the slide pin 528 may compress, accommodating for tolerances and misalignments within the space between the first and second components.

FIGS. 6A-6B illustrate a side view of a slide pin sliding member for the exemplary linear motion assembly according to a number of embodiments. As seen in FIGS. 6A, 6B, the slide pin 628 may include a substrate 638 and a low friction material 640. The substrate 638 can include a rigid material, such as a metal or a polymer. More particularly, the substrate 638 can include a steel, such as spring steel. The substrate 638 can define a generally cylindrical shape. In an embodiment, the substrate 638 may be solid, devoid of hollow portions. In an alternate embodiment, the substrate 638 may be hollow, including a cavity, such as a central cavity. Solid substrates may be more suitable for load bearing application whereas hollow substrates may accommodate misalignment and tolerances between the receivers. Thus, suitable substrate configuration may be determined based on relative location within the linear motion assembly. In certain embodiments, all of the slide pins may be the same as one another. In other embodiments, at least two slide pins in the assembly may be different from one another.

In certain embodiments, the substrate 638 may include an annular depression 642 having a diameter less than a maximum diameter of the substrate 638 (e.g., FIG. 6A). For example, the diameter of the annular depression 642 may be no greater than 99% of the maximum diameter of the substrate, such as no greater than 98% of the maximum diameter of the substrate, no greater than 97% of the maximum diameter of the substrate, no greater than 96% of the maximum diameter of the substrate, no greater than 95% of the maximum diameter of the substrate, no greater than 90% of the maximum diameter of the substrate, or even no greater than 75% of the maximum diameter of the substrate. Moreover, the diameter of the annular depression 642 can be no less than 25% of the maximum diameter of the substrate.

In a further embodiment, the substrate 638 can include at least two annular depressions, such as at least three annular depressions, or even at least four annular depressions. The annular depressions may extend entirely around the circumference of the substrate 638 or along a portion of the circumference of the substrate. The annular depressions may have the same dimensional characteristics with respect to each other. In another embodiment, at least two of the annular depressions can have different dimensional characteristics with respect to each other.

In an embodiment, the annular depression 642 can be centrally disposed along the length of the substrate 638. In another embodiment, the annular depression 642 can be offset from the middle portion 630 of the substrate 638. For example, the annular depression 642 may be offset from the middle portion 630 by at least 1% of the length of the substrate, such as by at least 2% of the length of the substrate, by at least 3% of the length of the substrate, by at least 4% of the length of the substrate, by at least 5% of the length of the substrate, by at least 10% of the length of the substrate, by at least 15% of the length of the substrate, by at least 20% of the length of the substrate, by at least 25% of the length of the substrate, by at least 30% of the length of the substrate, by at least 35% of the length of the substrate, by at least 40% of the length of the substrate, or even by at least 45% of the length of the substrate. In an embodiment, the annular depression 642 may be offset from the middle portion 630 by no greater than 50% of the length of the substrate, such as by no greater than 49% of the length of the substrate, by no greater than 48% of the length of the substrate, by no greater than 47% of the length of the substrate, or even by no greater than 46% of the length of the substrate.

The annular depression 642 can extend along at least 10% of the length of the substrate, along at least 20% of the length of the substrate, along at least 30% of the length of the substrate, along at least 40% of the length of the substrate, or even along at least 50% of the length of the substrate. In an embodiment, the annular depression 642 can extend along no greater than 80% of the length of the substrate, such as no greater than 70% of the length of the substrate.

The low friction material 640 can extend around a circumference of the substrate 638 so as to form an outer layer of the slide pin 628. The low friction material 640 can contact an outer surface of the substrate 638 along at least a portion thereof. Those embodiments including an annular depression 642 may include a void 644 between the outer surface of the substrate 638 and an inner surface of the low friction material 640, as seen in the preinstalled state. In certain embodiments, upon installation, the low friction material 640 can at least partially collapse into the void 644 (FIG. 6B). This may allow the slide pin 628 to adjust for the tolerances and misalignments between the receivers.

In an embodiment, the low friction material 640 can be coupled to at least a portion, such as all, of the substrate 638. In a particular embodiment, the low friction material 640 can be extruded or molded over the substrate 638. The low friction material 640 may be overmolded, injection molded, or otherwise positioned over the substrate 638 in a molten, or semi-molten state.

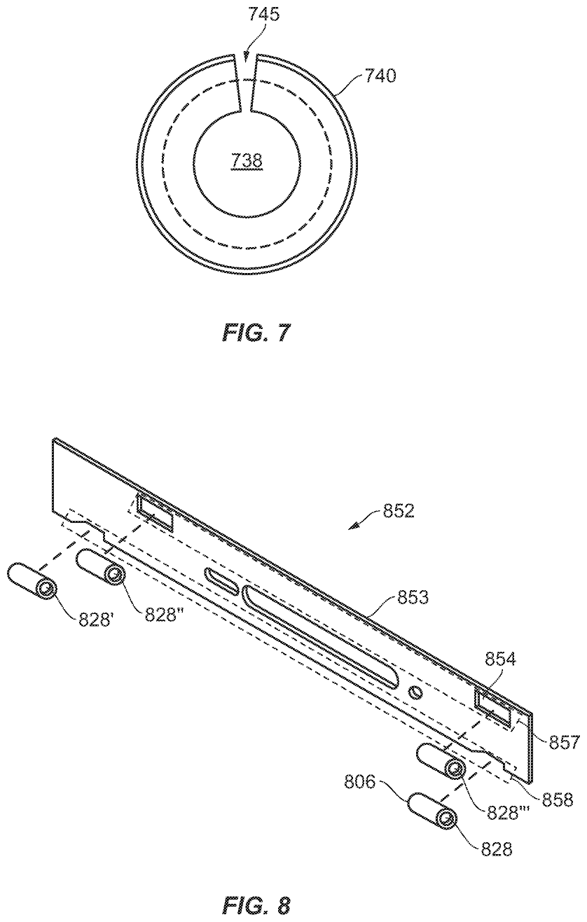

In another embodiment, as shown best in FIG. 7, the low friction material 740 can include a generally hollow cylinder. The substrate 738 can be urged into the hollow interior of the cylinder, for example, by pressing the substrate 738 in a direction between opposing axial ends of the low friction material 740. In an embodiment, the low friction material 740 can include a gap 745. The gap 745 may extend along at least a portion of the axial length of the low friction material 740. More particularly, the gap 645 may extend along the entire axial length of the low friction material 740. In an embodiment, the circumferential ends of the low friction material 740 may be spaced apart by at least 1°, such as at least 2°, at least 3°, at least 4°, at least 5°, or even at least 10°. In particular embodiments, the gap may allow the substrate 738 to pass into the hollow interior of the cylinder in a transverse direction.

Referring back to FIGS. 6A-6B, in yet a further embodiment, the low friction material 640 can include a rolled sheet of low friction material. A blank may be cut from a sheet of material. The sheet of material may be homogenous or have a composite construction. The blank can include a polygonal shape, an arcuate shape, or a combination thereof. The blank can be rolled into a generally cylindrical shape (e.g., a barrel shape). Rolling can occur around the substrate 638 or around a template structure. The rolled sheet of material can then be fixed relative to the substrate 638. In an embodiment, fixing of the rolled sheet of material can occur by bending, or crimping, the ends of the low friction material adjacent to the axial ends of the substrate 638. In a particular instance, this can leave a portion of the substrate 638 exposed such that it is visible. In another instance, sizing of the blank can be done such that crimping of the low friction material completely covers the substrate 638. A gap may be present along the axial length of the slide pin. In an embodiment, the gap can be closed, for example, by welding, adhesion, a mechanical interconnect (e.g., a puzzle-piece interface), another suitable method, or any combination thereof.

In particular embodiments, the slide pin 628 can include a low friction material 640 without an internally disposed substrate. The low friction material 640 may include any of the characteristics as described above. For example, the low friction material 640 may include a gap 645 extending along at least a portion of the axial length of the low friction material 640. Usage of a slide pin 628 without an internal substrate may permit greater geometric flexibility. This may enhance tolerance absorption capacity of the slide pin 628.

In an embodiment, the low friction material 640 can define a sidewall thickness, T_{S}, less than a diameter of the substrate 638. For example, the diameter of the substrate 638 can be greater than 1.1 T_{S}, such as greater than 1.5 T_{S}, greater than 2 T_{S}, greater than 3 T_{S}, greater than 4 T_{S}, greater than 5 T_{S}, greater than 6 T_{S}, greater than 7 T_{S}, greater than 8 T_{S}, greater than 9 T_{S}, greater than 10 T_{S}, greater than 15 T_{S}, greater than 20 T_{S}, greater than 25 T_{S}, greater than 50 T_{S}, or even greater than 75 T_{S}. In certain embodiments, the diameter of the substrate 638 can be no greater than 500 T_{S}, such as no greater than 250 T_{S}, or even no greater than 100 T_{S}.

In an embodiment, T_{S} can be at least 0.1 mm, such as at least 0.5 mm, at least 1 mm, at least 2 mm, at least 3 mm, at least 4 mm, at least 5 mm, or even at least 10 mm. In an embodiment, T_{S} can be no greater than 75 mm.

The low friction material 640 can be adhered or otherwise secured to the substrate 638 by an adhesive or a mechanical fixture, such as a pin or collar. Alternatively, the low friction material 640 can freely float relative to the substrate 638, permitting relative rotational or axial movement therebetween. In such a manner, the low friction material 640 may slide or rotate relative to the substrate 638.

During installation, the slide pin 628 may be longitudinally insertable between the first and second components. In an embodiment, the slide pin 628 can include a rounded edge 646 disposed between the sidewall and at least one of the opposing end portions 632. The rounded edge 646 may act as a guide portion. The rounded edge 646 may facilitate easier alignment between the slide pin 628 and the first and second components. In an embodiment, the rounded edge 646 can have a radius of curvature in a range of 0.1 mm and 50 mm, such as in a range of 0.5 mm and 10 mm, or even in a range of 1 mm and 2 mm. In an embodiment, the radius of curvature can be no greater than 10 mm. In a more particular embodiment, the radius of curvature can be approximately 1 mm.

Referring again to FIG. 5, one or more of the slide pins 528 may include at least one opposing axial cavity 548. FIG. 8 illustrates an exploded partial perspective view of an exemplary linear motion assembly according to a number of embodiments. Referring now to FIG. 8, a pin, post, or other member (not illustrated) of the retention frame 852 may be at least partially inserted into the at least one opposing axial cavity of the slide pins 828 (i.e. sliding members 806). The at least one opposing axial cavity may form an interference fit with the retention frame 852, preventing relative disconnection therefrom. In a number of embodiments, the retention frame 852 can include a rigid material, such as a metal or a polymer.

The retention frame 852 may include a body 853 having a plurality of openings 854 disposed therein. The body 853 may include a relatively rigid material, e.g., a rigid polymer, a metal, or an alloy. In an embodiment, the body 853 may have a length, L_{F}, no greater than the length of the first and second component of the linear motion assembly. For example, the length of the linear motion assembly may be at least 1.0 L_{F}, such as at least 1.01 L_{F}, at least 1.02 L_{F}, at least 1.03 L_{F}, at least 1.04 L_{F}, at least 1.05 L_{F}, at least 1.1 L_{F}, or even at least 1.25 L_{F}. In a further embodiment, the length of the linear motion assembly may be no greater than 50 L_{F}, such as no greater than 25 L_{F}, no greater than 10 L_{F}, no greater than 5 L_{F}, or even no greater than 2 L_{F}.

In an embodiment, the body 853 can have a thickness, as measured between opposing major surfaces thereof, of at least 0.1 mm, such as at least 0.5 mm, at least 1 mm, or even at least 5 mm. In a further embodiment, the thickness can be no greater than 50 mm, such as no greater than 20 mm, or even no greater than 10 mm.

The openings 854 can each be sized and shaped to receive a slide pin 828. In a particular embodiment, at least one of the openings 854 may have a generally polygonal shape. In a more particular embodiment, at least one of the openings 854 may have a generally rectangular shape. In another embodiment, at least one of the openings 854 may have an ellipsoidal shape. In a more particular embodiment, at least one of the openings 854 may have an ovular shape. In certain embodiments, at least two of the openings 854 may have a same or similar shape with respect to each other. In a further embodiment, all of the openings 854 may have the same shape with respect to each other. In another embodiment, at least two of the openings 854 may have different shapes with respect to each other. The opposing axial cavities of the slide pins 828 can couple with the body 853. In an embodiment, the slide pins 528 can freely rotate or slide within the openings 854.

In an embodiment, the retention frame 852 may include two rows of openings 854, e.g., a top row 857 and a bottom row 858. In a particular embodiment, the top and bottom rows 857 and 858 can be spaced apart and extend in parallel with respect to each other.

Additional openings may be disposed along the body 853, for example, between rows 857 and 858. The additional openings may reduce mass of the body 853. In an embodiment, a component can be disposed within at least one of the additional openings to further enhance relatively slidability within the rail.

The retention frame 852 can be shaped to fit between the first and second components. In such a manner, the assembled retention frame 852 and slide pins 828 may be quickly installed within the first and second components. In certain embodiments, the retention frame 852 may float with respect to the first and second components. That is, the retention frame 852 may not contact either of the first and second components.

In an embodiment, the top and bottom rows 857 and 858 of the retention frame 852 can include different sliding members 806. In a particular embodiment, at least one sliding member 806 can be disposed within the top row 857 of openings 854 in the retention frame 852 while at least one slide pin 828 can be disposed within the bottom row 858 of the openings 854 of the retention frame 852.

Oversizing the openings 854 of the retention frame 852 may allow for better tolerance and misalignment absorption between the first and second components. This may reduce the occurrence of noise, vibration, and the transfer of harshness (NVH) within the linear motion assembly, which may result in smoother and quieter passenger experience. In an embodiment, the diameter of the openings 854 of the retention frame 852, as measured in the undeformed state, can be at least 1.01 the diameter of at least one of the slide pins 828, such as at least 1.02 the diameter of at least one of the slide pins, at least 1.03 the diameter of at least one of the slide pins, at least 1.04 the diameter of at least one of the slide pins, at least 1.05 the diameter of at least one of the slide pins, at least 1.1 the diameter of at least one of the slide pins, or even at least 1.15 the diameter of at least one of the slide pins. In a more particular embodiment, the diameter of the openings 854 of the retention frame 852, as measured in the undeformed state, can be at least 1.01 the diameter of all of the slide pins 828, such as at least 1.02 the diameter of all of the slide pins, at least 1.03 the diameter of all of the slide pins, at least 1.04 the diameter of all of the slide pins, at least 1.05 the diameter of all of the slide pins, at least 1.1 the diameter of all of the slide pins, or even at least 1.15 the diameter of all of the slide pins.

Skilled artisans will recognize after reading this description that while first and second component designs vary, it may be generally desirable to position load bearing sliding members 806 in certain positions within the components. In such a manner, sliding members 806 including rigid substrates may support vertical loads, while empty openings 854 of the retention frame 852 may provide superior tolerance compensation.

In accordance with one or more embodiments described herein, it may be possible to provide improved alignment within a linear motion assembly, causing improved force control and proper tolerance compensation, ultimately providing more efficient sliding performance of the assembly.

Many different aspects and embodiments are possible. Some of those aspects and embodiments are described below. After reading this specification, skilled artisans will appreciate that those aspects and embodiments are only illustrative and do not limit the scope of the present invention. Embodiments may be in accordance with any one or more of the embodiments as listed below.

Embodiment 1: A linear motion assembly comprising: a first component; a second component; and a sliding member disposed between the first and second components; and a retention system adapted to retain the sliding member between the first component and the second component, wherein the retention system comprises a retention frame and at least one spring element, wherein the sliding member is disposed between the retention frame and the spring element, wherein the spring element provides a biasing force on the sliding member.

Embodiment 2: A linear motion assembly comprising: a first component; a second component; and a plurality of sliding members disposed between the first and second components; and a retention system comprising a plurality of spring elements, wherein a first spring element of the plurality of spring elements provides a first biasing force on a first sliding member of the plurality of sliding members, and a second spring element of the plurality of spring elements provides a second biasing force on a second sliding member of the plurality of sliding members, wherein the first biasing force is independent from the second biasing force.

Embodiment 3: The linear motion assembly according to any one of embodiments 1-2, wherein the spring element comprises a plurality of spring elements.

Embodiment 4: The linear motion assembly according to any one of embodiments 1-2, wherein the spring element contacts the sliding member and at least one of the first component or the second component.

Embodiment 5: The linear motion assembly according to any one of embodiments 1-2, wherein the spring element contacts the sliding member and both of the first component and the second component.

Embodiment 6: The linear motion assembly according to any one of embodiments 1-2, wherein the spring element is fixed to at least one of the first component or the second component.

Embodiment 7: The linear motion assembly according to any one of embodiments 1-2, wherein the spring element fits within a bore of at least one of the first component or the second component.

Embodiment 8: The linear motion assembly according to embodiment 7, wherein the spring element runs completely through the bore of at least one of the first component or the second component.

Embodiment 9: The linear motion assembly according to any one of embodiments 1-2, wherein the spring element comprises a metal.

Embodiment 10: The linear motion assembly according to any one of embodiments 1-2, wherein the retention frame comprises a metal or polymer.

Embodiment 11: The linear motion assembly according to any one of embodiments 1-2, wherein the retention frame comprises a plurality of openings, each opening adapted to house at least one sliding member.

Embodiment 12: The linear motion assembly according to any one of embodiments 1-2, wherein the retention frame is fixed to at least one of the first component or the second component.

Embodiment 13: The linear motion assembly according to any one of embodiments 1-2, wherein at least one of the first component or the second component has a concave exterior surface adapted to house the sliding member.

Embodiment 14: The linear motion assembly according to any one of embodiments 1-2, wherein the sliding member is adapted to longitudinally translate with respect to at least one of the first component or the second component.

Embodiment 15: The linear motion assembly according to any one of embodiments 1-2, wherein the first component is adapted to longitudinally translate with respect to the second component.

Embodiment 16: The linear motion assembly according to any one of embodiments 1-2, wherein the second component is adapted to longitudinally translate with respect to the first component.

Embodiment 17: The linear motion assembly according to any one of embodiments 1-2, wherein the sliding member comprises a slide pin.

Embodiment 18: The linear motion assembly according to embodiment 17, wherein the slide pin comprises an elongated cylinder.

Embodiment 19: The linear motion assembly according to embodiment 17, wherein the slide pin comprises a barrel shape.

Embodiment 20: The linear motion assembly according to embodiment 17, wherein the slide pin maintains a constant angle relative to a central axis, as measured from an end portion to a middle portion of the slide pin.

Embodiment 21: The linear motion assembly according to embodiment 17, wherein the slide pin has a varying angle relative to a central axis, as measured from an end portion to a middle portion of the slide pin.

Embodiment 22: The linear motion assembly according to embodiment 17, wherein the slide pin deforms to a generally cylindrical shape when assembled between the first component and the second component.

Embodiment 23: The linear motion assembly according to embodiment 17, wherein the slide pin comprises a low friction material.

Embodiment 24: The linear motion assembly according to embodiment 23, wherein the low friction material comprises a polymer.

Embodiment 25: The linear motion assembly according to embodiment 17, wherein the slide pin comprises a substrate.

Embodiment 26: The linear motion assembly according to embodiment 25, wherein substrate comprises a metal.

Embodiment 27: The linear motion assembly according to embodiment 25, wherein the substrate comprises at least one annular depression having a diameter less than a maximum diameter of the substrate.

Embodiment 28: The linear motion assembly according to embodiment 27, wherein the diameter of the annular depression is no greater than 99% and no less than 25% of the maximum diameter of the substrate.

Embodiment 29: The linear motion assembly according to embodiment 27, wherein the annular depression is centrally disposed along a length of the substrate.

Embodiment 30: The linear motion assembly according to embodiment 27, wherein the annular depression is offset from being centrally disposed along a length of the substrate.

Embodiment 31: The linear motion assembly according to embodiment 27, wherein the annular depression extends at least 0% and no greater than 80% along a length of the substrate.

Embodiment 32: The linear motion assembly according to embodiment 23, wherein low friction material extends around a circumference of the substrate.

Embodiment 33: The linear motion assembly according to embodiment 23, wherein low friction material is contacts the substrate along at least a portion thereof.

Embodiment 34: The linear motion assembly according to embodiment 23, wherein low friction material is coupled to the substrate along at least a portion thereof by an adhesive or mechanical fixture.

Embodiment 35: The linear motion assembly according to embodiment 23, wherein the low friction material comprises a generally hollow cylinder.

Embodiment 36: The linear motion assembly according to embodiment 23, wherein the low friction material comprises a gap extending along at least a portion of an axial length thereof.

Embodiment 37: The linear motion assembly according to any one of embodiments 1-2, wherein the at least one spring element provides a biasing force on at least one of the plurality of sliding members of at least 0.01 and not greater than 500N.

Embodiment 38: The linear motion assembly according to any one of embodiments 1-2, wherein the first biasing force is greater than the second biasing force.

Embodiment 39: The linear motion assembly according to any one of embodiments 1-2, wherein the first biasing force is less than the second biasing force.

Embodiment 40: The linear motion assembly according to any one of embodiments 1-2, wherein the first biasing force is the same as the second biasing force.

Embodiment 41: The linear motion assembly according to any one of embodiments 1-2, wherein the at least one spring element is a coil spring, a blade spring, or leaf/feather spring.

Embodiment 42: The linear motion assembly according to embodiment 40, wherein the at least one spring element has a rectangular, square, or keystone cross-sectional wire.

Embodiment 43: The linear motion assembly according to embodiment 40, wherein the at least one spring element has a circular cross-sectional wire.

Embodiment 44: The linear motion assembly according to any one of embodiments 1-2, wherein the at least one spring element is an elastomeric material providing a biasing force while compressed.

Note that not all of the features described above are required, that a portion of a specific feature may not be required, and that one or more features may be provided in addition to those described. Still further, the order in which features are described is not necessarily the order in which the features are installed.

Certain features are, for clarity, described herein in the context of separate embodiments, may also be provided in combination in a single embodiment. Conversely, various features that are, for brevity, described in the context of a single embodiment, may also be provided separately or in any subcombinations.

Benefits, other advantages, and solutions to problems have been described above with regard to specific embodiments, However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or any change may be made without departing from the scope of the disclosure. Accordingly, the disclosure is to be regarded as illustrative rather than restrictive.

What is claimed is:

1. A linear motion assembly comprising:
a first component;
a second component; and
a sliding member disposed between the first and second components; and
a retention system adapted to retain the sliding member between the first component and the second component, wherein the retention system comprises a retention frame and at least one spring element, wherein the sliding member is disposed between the retention frame and the spring element, wherein the spring element provides a biasing force on the sliding member.

2. A linear motion assembly comprising:
a first component;
a second component; and
a plurality of sliding members disposed between the first and second components; and
a retention system comprising a plurality of spring elements, wherein a first spring element of the plurality of spring elements provides a first biasing force on a first sliding member of the plurality of sliding members, and a second spring element of the plurality of spring elements provides a second biasing force on a second sliding member of the plurality of sliding members, wherein the first biasing force is independent from the second biasing force.

3. The linear motion assembly according to claim 1, wherein the spring element comprises a plurality of spring elements.

4. The linear motion assembly according to claim 1, wherein the spring element contacts the sliding member and at least one of the first component or the second component.

5. The linear motion assembly according to claim 1, wherein the spring element contacts the sliding member and both of the first component and the second component.

6. The linear motion assembly according to claim 1, wherein the spring element is fixed to at least one of the first component or the second component.

7. The linear motion assembly according to claim 1, wherein the spring element fits within a bore of at least one of the first component or the second component.

8. The linear motion assembly according to claim 1, wherein the retention frame comprises a plurality of openings, each opening adapted to house at least one sliding member.

9. The linear motion assembly according to claim 1, wherein the retention frame is fixed to at least one of the first component or the second component.

10. The linear motion assembly according to claim 1, wherein at least one of the first component or the second component has a concave exterior surface adapted to house the sliding member.

11. The linear motion assembly according to claim 1, wherein the sliding member is adapted to longitudinally translate with respect to at least one of the first component or the second component.

12. The linear motion assembly according to claim 1, wherein the first component is adapted to longitudinally translate with respect to the second component.

13. The linear motion assembly according to claim 1, wherein the second component is adapted to longitudinally translate with respect to the first component.

14. The linear motion assembly according to claim 1, wherein the sliding member comprises a slide pin.

15. The linear motion assembly according to claim 1, wherein the at least one spring element provides a biasing force on at least one of the plurality of sliding members of at least 0.01 and not greater than 500N.

16. The linear motion assembly according to claim 2, wherein the first biasing force is greater than the second biasing force.

17. The linear motion assembly according to claim 2, wherein the first biasing force is less than the second biasing force.

18. The linear motion assembly according to claim 1, wherein the first biasing force is the same as the second biasing force.

19. The linear motion assembly according to claim 1, wherein the at least one spring element is a coil spring, a blade spring, or leaf/feather spring.

20. The linear motion assembly according to claim 1 wherein the at least one spring element is an elastomeric material providing a biasing force while compressed.
